(19) United States
(12) Patent Application Publication
(10) Pub. No.: US 2004/0076118 A1
(43) Pub. Date: Apr. 22, 2004

(54) Explicit rate flow control for multicast connections

(75) Inventors: Esmond Ho, Kanata (CA); Charlie Sabry, Ottawa (CA)

Correspondence Address: MARKS & CLERK, P.O. BOX 957, STATION B, OTTAWA, ON, K1P 5S7, CA

(73) Assignee: Alcatel Canada Inc., Ontario (CA)

(21) Appl. No.: 10/682,201

(22) Filed: Oct. 10, 2003

Related U.S. Application Data
(63) Continuation of application No. 09/337,349, filed on Jun. 21, 1999.

(30) Foreign Application Priority Data
Dec. 24, 1998 (CA) 2,257,007

(51) Int. Cl. H04L 12/26

(52) U.S. Cl. 370/235; 370/252

(57) ABSTRACT

A method of providing flow control feedback about a contention point such as a queuing point to a source of a multicast ATM virtual connection. The method includes (1) identifying a slowest output stream of the multicast connection at the contention point; (2) executing an explicit rate (ER) calculation only with respect to accounting characteristics of the slowest output stream at the contention point; and (3) signaling a result of the slowest stream ER calculation back to the source, preferably by updating resource management (RM) cells flowing towards the source.

### CROSS REFERENCE TO RELATED APPLICATION

This application is a continuation of co-pending U.S. patent application Ser. No. 09/337,349, filed Jun. 21, 1999.

### FIELD OF INVENTION

The invention generally relates to the field of digital communication systems, and more particularly to a method and apparatus for providing an explicit rate flow control signal for a multicast connection in a digital communications network, particularly an asynchronous transfer mode (ATM) network.

### BACKGROUND OF INVENTION

In an ATM network, the available bit rate (ABR) service category is provided in order to cany data traffic which has no specific cell loss or delay guarantees. The ABR service category provides source-to-destination flow control that attempts, but is not guaranteed, to achieve zero cell loss. The ABR service category was defined in order to take advantage of available bandwidth within an ATM network during intervals when higher priority traffic is not completely utilizing the network capacity. In order to meet nominal cell loss guarantees ABR traffic employs a feedback loop which effectively monitors congestion at nodes throughout the network and periodically reports back to the source so that data traffic can be adjusted accordingly.

ABR flow control is achieved by the source sending special resource management (RM) cells through the network. Each switch in the network indicates its congestion status by optionally writing into the RM cell and forwarding the cell onto the next switch in the data path. Finally, the destination turns the RM cell back towards the source and the switches mark congestion information into the RM cell which is ultimately received by the source. The source then adjusts its sending rate in response to the information contained in the RM cell. In this manner, the RM cell acts as a feedback message from switches in the backward data path to the source.

The RM cell contains three fields which may be written to in order to describe the congestion status of the switch: a no increase (NI) bit which indicates that the source must not increase its sending rate; a congestion indication (CI) bit which indicates that the source must decrease its sending rate; and an explicit rate (ER) field which contains the minimum explicit rate calculated by any switch in the backward data path.

An explicit rate (ER) algorithm may be deployed at any contention point in the data path. For the purpose of this description a contention point is defined as a queuing point in which the aggregate arrival rate of cells is greater than the aggregate service rate. In the context of the present invention the service rate pertains to the capacity available to ABR and is in general time-dependent. A switch may have one or more contention points, and in practice an ER algorithm is typically deployed for every ABR queuing point in the network.

ATM protocols typically do not specify the algorithms to be used for computing ER values. This is a vendor specific choice. Many algorithms have been developed to determine the ER value associated with a connection path at a contention point. Many of these algorithms determine ER values based on certain accounting information relating to the input and/or output sides of a queuing point. For example, the algorithm described by Cathy Fulton et al, “UT: ABR Feedback Control with Tracking”, ATM Forum 96-1540 Traffic Management, attempts to track the total bandwidth available to ABR at a contention point with the aggregate arrival rate, and requires a switch to implement aggregate input and output rate monitoring at each contention point. Another ER algorithm proposed for congestion control of ABR traffic is disclosed in U.S. patent application Ser. No. 08/878,964 filed Jun. 19, 1997 by Tom Davis et al., owned by the instant assignee, which is incorporated by reference herein. This algorithm determines ER values as a function of the aggregate ABR queue depth associated with a given output port. These algorithms are based on unicast connections, and therefore are not readily extendible to multicast connections due to the increased accounting at the input side of a queuing point, which increases in proportion to the number of data streams which branch out from the queuing point. For instance, it is possible for ATM networks to permit multicast connections comprising over 4k destinations or leaves, and thus it becomes impractical to carry out a great number of simultaneous ER calculations. Hence, a more economical technique is desired.

### SUMMARY OF INVENTION

The invention provides a method that applies known ER algorithms previously used with unicast connections to multicast connections in order to provide an explicit rate feedback. Broadly speaking, this is accomplished by identifying the slowest stream of a multicast connection at a contention point, applying an ER calculation using the accounting characteristics of the slowest stream at the contention point, and transmitting a result of the slowest stream ER calculation back to the data traffic source. This method is advantageous in that it can be relatively quickly and economically applied. In addition, in the preferred embodiment, the data transmission rate of the source is controlled by the slowest stream, therefore all leaves receive data substantially synchronously.

In the preferred embodiment, the multicast connection is set up as an asynchronous transfer mode (ATM) available bit rate (ABR) connection, and the step of transmitting includes writing ER calculation results in resource management (RM) cells flowing towards the source.

Also in the preferred embodiment, the contention point is a memory buffer for storing cells received from the source in a temporally ordered linked list. Multicasting is effected by copying cells from the linked list to various ports associated with various streams branching out from the contention point. A read pointer is maintained for each such stream to provide an index into the linked list, and the step of identifying the slowest stream includes identifying the read pointer associated with a temporally earliest cell in the linked list.

### BRIEF DESCRIPTION OF DRAWINGS

The foregoing and other aspects of the preferred embodiments of the invention are described in greater detail below with reference to the following drawings, provided for the purposes of illustration and not of limitation, wherein:

FIG. 1 is a schematic diagram of a unidirectional unicast connection and an associated explicit rate flow control feedback signal or connection established over a reference network;

FIG. 2 is a schematic diagram of a unidirectional multicast connection and an associated explicit rate flow control feedback signal or connection established over the reference network;

FIG. 3 is a system block diagram of the architecture of a preferred network node which includes multiple queuing points therein;

FIG. 4 is a schematic diagram illustrating a data structure for effecting multicasting using a single physical memory buffer; and

FIG. 5 is a schematic diagram of an exemplary relationship between various connections and output ports on a network node.

### DETAILED DESCRIPTION OF PREFERRED EMBODIMENTS

FIG. 1 illustrates the general principles of the explicit rate flow control technique in the context of an ATM network 10. A unidirectional unicast connection is illustrated between a source CPE (customer premise equipment) 12 and a destination CPE 14. User data flows unidirectionally between the source and destination CPE 12 and 14 over or through network nodes 15 along path 18. In accordance with the ATM protocol, CPE 12 and 14 generate an RM cell flow 20. The RM cell flow carries ER values calculated by contention points along path 18 back to the source CPE 12 which adjusts its data transmission rate accordingly. It will be appreciated that in a bi-directional unicast connection, each CPE 12 or 14 functions as both a ‘source’ and ‘destination’, whereby user data also flows from CPE 14 to CPE 12 and a corresponding RM cell flow is established therebetween.

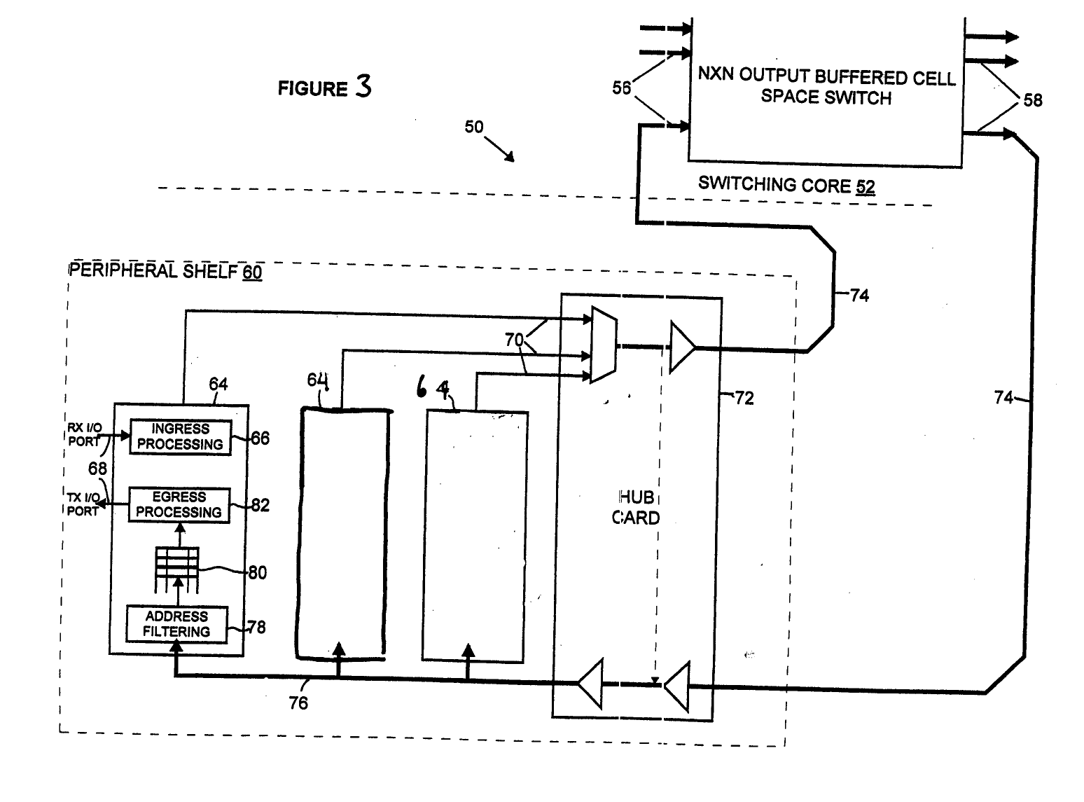

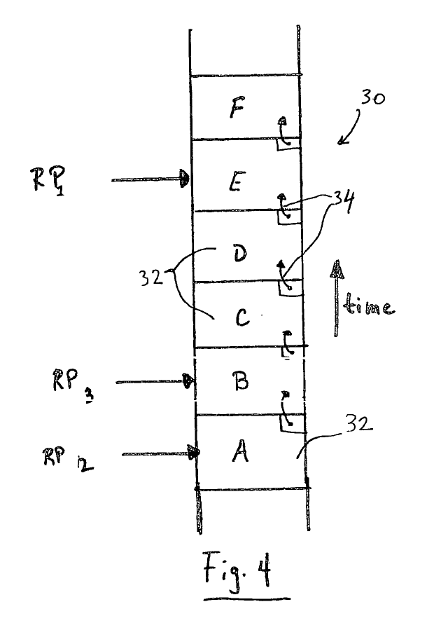

There may be many potential contention points along path 18, the number of which will depend on the type of network equipment employed. FIG. 3 shows as an non-exhaustive example only the basic architecture of a model 36170 MainStreetXpress™ network switch manufactured by Newbridge Network Corporation of Kanata, Ontario, Canada. The switch comprises a high capacity switching core 52 having N inputs 56, any of which can be switched to any or all of N outputs 58. The switch 50 further comprises one or more accessory or peripheral shelves 60 (only one being shown) which feature a plurality of universal card slots (UCS) 62 for housing interface cards or system cards.

One example of an interface card is cell relay card 64. Card 64 comprises an ingress processing module 66 for converting, if necessary, incoming data from the input side of a input/output port 68 into ATM-like cells. The ingress processing module 66 also examines the VPI/VCI field of the ATM cell and, based on this field, attaches an internal tag or header to the ATM cell which is used to identify an internal address that the ATM cells should be routed t₀. The ATM cell including the priority tag is then routed toward the switching core 52 over an ‘add’ bus 70.

A hub card 72, which is one type of system card, multiplexes a plurality of add buses 70 from the various interface cards on shelf 60 to a high speed “intershelf link” (ISL) bus 74 which connects the shelf 60 with the switching core 52. The hub card also terminates the ISL bus 74 from the switching core 52 and drives a multi-drop bus 76. In this manner, any interface or system card can communicate with any other interface or system card. In order to multiplex the add buses 70 from the various cards, the hub card 72 typically queues or buffers ABR cells so that higher priority traffic can be forwarded to the switching core 52. The hub card is thus one example of a queuing point in the switch.

The cell relay card 64 includes a backplane or address filtering module 78 for monitoring the multi-drop bus 76 and copying or receiving any data cell thereon which is addressed to the card 64. The multi-drop bus 76 operates at a relatively high speed, e.g., 800 Mb/s, and thus the card 64 may receive more ATM data cells then it can instantaneously deal with. In order to prevent cell loss, card 64 includes an output queuing module 80 for buffering outgoing cells. This too is a queuing point. An egress processing module 82 retrieves cells from the queues established by the queuing module 80 and maps the cells into the specific format of the interface for transmission on the output side of port 68.

In practice, an ER calculation is typically carried out for each such queuing point. The locally computed ER value is compared to the ER field of a counter-flowing RM cell (which carries an ER value computed in relation to an upstream contention point), and if the former is less than the latter, the ER field is updated. An RM cell can thus be considered to be carrying a ‘global ER value’ which informs the source with respect to the most constraining congestion along the user data flow path 18 at a particular period of time. Nevertheless, it will be understood that the process of signaling a feedback message to the source about a queuing point includes the action of comparing the local ER value against the global ER value and not updating the latter where the local ER value is greater than the global ER value.

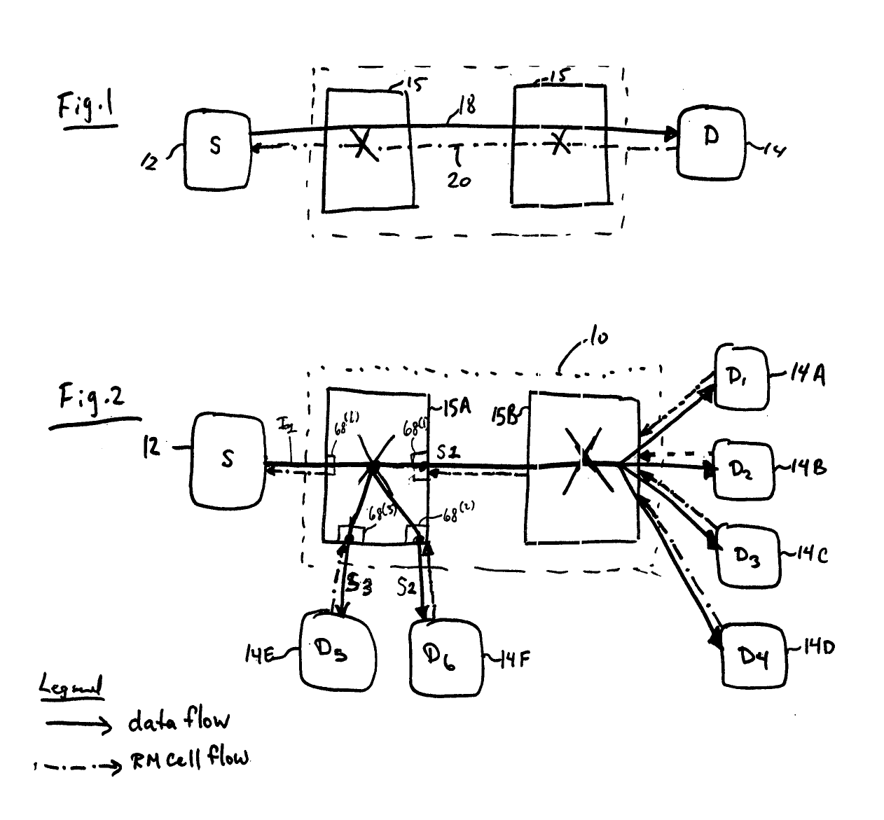

FIG. 2 illustrates a unidirectional multicast connection between a source CPE (customer premise equipment) 12 and multiple destination CPEs 14A-14F. User data flows unidirectionally between the source and multiple destination CPEs along plural paths over or through network nodes 15 as indicated in the drawing. In accordance with the ATM protocol, each destination CPE 14A-14F (or network nodej generates an RM cell flow towards the preceding network node the CPE is connected to. The network nodes consolidate the separate RM cell flows to provide a single RM cell flow back to the source CPE. (Note that the transmission rate of the single RM cell flow need not necessarily be equal to the sum of the transmission rates of the separate RM cell flows.) For example, node 15A consolidates RM cell flows emanating from CPE 14E, CPE 14F and network node 15B.

The preferred embodiment provides feedback about a contention point to source CPE 12 by identifying a slowest stream of the multicast connection at the contention point, and by using the accounting characteristics associated with the slowest stream to compute a local ER value according to a pre-specified ER algorithm. This ER value is carried or signaled back, as described above, to the source. No ER calculations are made in relation to the other streams which branch out from the contention point.

For example, consider node 15A. An input stream of cells 11 enters input port 68(i) and a copy of each cell received on that port is forwarded to three output ports 68(1), 68(2), and 68(3), such that three identical (with the exception of a potential phase delay) data streams S1, S2 and S3, branch out from the input stream I₁. In the 36170 MainStreetXpress™ switch, the cells are buffered in the hub card 72 before being forwarded to output ports 68(1), 68(2), and 68(3). The buffering technique may be effected by employing three separate buffers, one for each stream, or three logical buffers using one physical buffer, as explained in greater detail below.

Assume that the selected ER algorithm is the previously mentioned Davis et al. algorithm which computes a local ER value as a function of the aggregate queue depth or occupancy of all ABR connections associated with a particular output port. In applying the ER calculation, the slowest data stream at a particular instant of time is identified. This is the stream having the slowest data transmission rate, and thus the identification can be made by finding the slowest data transmission rate amongst streams S1, S2 and S3. The slowest stream can also be identified by finding the output stream having the greatest phase delay with respect to the input stream. This is preferably accomplished by determining the longest queue (physical or logical) associated with streams S1, S2 and S3. Other methods of determining the slowest stream will be apparent to those skilled in this art. Once the slowest stream is identified, its associated port is determined and the aggregate ABR queue depth associated therewith is utilized as an input to the Davis et al. ER algorithm.

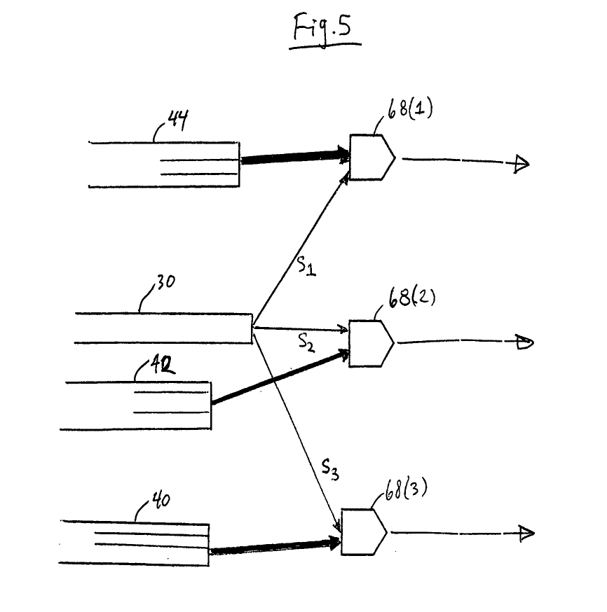

In the preferred embodiment, the hub card 72 employs only one physical buffer or queue into which all cells received from input port 68(i) are stored. The buffer is preferably organized as a number of temporally ordered linked lists 30, one of which is exemplified in FIG. 4, in order to implement per VC queuing. (The links between cells 32 are shown in FIG. 4. by the arrows bearing ref. no. 34.) The hub card 72 employs read pointers RP1, RP2 and RP3, one for each stream S1, S2 and S3, as indexes into the linked list 30. Since output ports 68(1), 68(2), and 68(3) may provide differing data transmission rates, and since the traffic volume through these port may differ, the hub card 72 may copy cells 32 from the linked list to the output ports, and hence streams S1, S2 and S3, at different rates. In such a system each read pointer functions as a place holder or index into the linked list for the corresponding output stream and indicates the next cell which must be copied to the output stream. When the read pointer associated with a temporally earliest cell in the linked list moves forward, and provided no other read pointer is pointing to that cell, the cell is physically de-queued since it has already been submitted to all the output ports or streams. For example, in the scenario shown in FIG. 4, cell A will be dequeued when read pointer RP2 moves forward. In this manner, the hub card 72 provides multiple logical buffers using a single physical buffer. Accordingly, the longest logical buffer and slowest output stream amongst S1, S2 and S3 is readily identified by noting the read pointer which points to the temporally earliest cell in the linked list 30.

As mentioned, the aggregate ABR queue depth of the port associated with the slowest stream is utilized as an input to the Davis et al. ER algorithm. In the preferred embodiment, a separate aggregate ABR queue depth (AAQD) counter is maintained for each output port. Whenever a “new” slowest stream is identified, a book-keeping adjustment is made to these counters. For instance, referring to FIG. 5, assume that at time to the slowest stream of the multicast connection is S3. The AAQD count at time t₀ for output port 68(3) is equal to the depth of the linked list 30 with respect to stream S3 plus the aggregated ABR queue depth of all other unicast connections 40 associated with output port 68(3). The AAQD counts at time to for output ports 68(1) and 68(2) are equal to the aggregate ABR queue depth of unicast connections 42 and 44 associated with these ports, respectively. Note that the depth of linked list 30 is not included in these AAQD counts in order to prevent a “double accounting”. Consider that at time t₁ stream S2 associated with port 68(2) is identified as the slowest stream of the multicast connection at this node. In this case the AAQD count for port 68(2) is adjusted so that it includes the depth of the linked list 30 with respect to stream S2, whereas the AAQD count for port 68(3) is adjusted so that the depth of the linked list 30 with respect to stream S3 is deducted from the previous AAQD value.

The invention has been described with a certain degree of particularity for the purposes of description. Those skilled in the art will appreciate that numerous modifications and variations may be made to the preferred embodiments disclosed herein without departing from the spirit and the scope of the invention.

We claim:

1. A method of providing feedback about a contention point to a source of a multicast connection, the method comprising:
identifying a slowest stream of the multicast connection at the contention point;
executing an explicit rate (ER) calculation only with respect to accounting characteristics of the slowest stream at the contention point;
transmitting a result of the slowest stream ER calculation back to the source; and
controlling a data transmission rate of said source of said multicast connection using said slowest stream ER calculation.

2. The method according to claim 1, wherein the multicast connection is set up as an asynchronous transfer mode (ATM) available bit rate (ABR) connection, and said step of transmitting includes writing ER calculation results in resource management (RM) cells flowing towards the source.

3. The method according to claim 1, wherein:
the contention point includes a memory buffer for storing cells received from the source in a temporally ordered linked list;
multicasting is effected by copying cells from the linked list to ports associated with the various multicast connection streams, and a read pointer is maintained for each stream to provide an index into the linked list; and
said step of identifying the slowest stream includes identifying the read pointer associated with a temporally earliest cell in the linked list.

4. The method according to claim 3, wherein the multicast connection is set up as an asynchronous transfer mode (ATM) available bit rate (ABR) connection, said packets are cells, and said step of transmitting includes writing ER calculation results in resource management (RM) cells flowing towards the source.
